(19) United States
(12) Patent Application Publication
(10) Pub. No.: US 2006/0159893 A1
(43) Pub. Date: Jul. 20, 2006

(54) Decorative articles for automotive glazing and methods of making same

(75) Inventors: Kevin S. Carney, Farmington Hills, MI (US); Bernie Weidl, Novi, MI (US); Helmut D. Klassen, Niagara-On-The-Lake (CA); Rodney B. Watson, Northville, MI (US); Steven D. Smith, Lebanon, TN (US)

Correspondence Address: MACMILLAN, SOBANSKI & TODD, LLC, One Maritime Plaza, Fourth Floor, 720 Water Street, Toledo, OH, 43604-1853, US

(73) Assignee: Visteon Global Technologies, Inc.

(21) Appl. No.: 11/039,291

(22) Filed: Jan. 19, 2005

(51) Int. Cl. B44C 1/17

(52) U.S. Cl. 428/195.1

(57) ABSTRACT

The present invention features a decorative article for an automotive glazing. An interior layer, an exterior layer in side by side relation with the interior layer, and a vinyl layer with a decorative pattern are arranged so that the vinyl layer is disposed between the interior and exterior layers. A ceramic pattern layer is disposed on the interior layer opposite the vinyl layer. The ceramic pattern layer has light reflecting background for enhanced illumination of the decorative pattern of the vinyl layer.

### BACKGROUND OF THE INVENTION

The present invention relates to decorative articles and methods of making a reflective background for decorative articles using ceramic frits.

Ceramic frits have been applied to automotive glazing such as windshields, body glass, backlites, moonroofs, or sunroofs for a variety of purposes. For example, the ceramic coating can block partially or entirely the passage of light through the automotive glazing or a portion thereof, or can impart a color to the glass pane for decorative, aesthetic or functional purposes. The ceramic coating may be conductive to allow it to be used, for example, in conjunction with a defroster or window-heating unit. Ceramic frits are also used in vehicles to protect the adhesive that holds the glass in place from the ultraviolet rays of the sun, to hide electrical wires and other hardware behind the glass, as well as to provide a filter for the amount of sunlight allowed into the vehicle, i.e., “half tones” on the moonroof and certain backlites. Further purposes include using the ceramic frits to obscure a body opening, to block ultraviolet or infrared rays, as well as providing graphic patterns to the vehicle.

Any graphic pattern applied to the automotive glazing is visible from the exterior of the vehicle from two different light sources. One is the light source from the exterior of the vehicle that is reflected from the graphic pattern or from one or more of the glass's surfaces. The other is light rays from the interior of the vehicle that pass through to the exterior. Because of the relatively dark interior of most vehicles, the predominant source of light usually comes from the exterior. As a result, the graphic pattern undesirably appears unclear and muted, with a lack of definition of the graphic pattern.

### BRIEF SUMMARY OF THE INVENTION

This invention generally provides a decorative article on automotive glazing with improved clarity. This result is accomplished by adding a predetermined pattern of ceramic frits to provide a reflective background for illuminating the decorative pattern.

Embodiments of the invention may have one or more of the following advantages. Although numerous shades of ceramic frits are available currently, they are not used to provide a contrasting or reflecting background to a decorative pattern on an automotive glazing. The ceramic pattern layer with a reflecting background provides a contrast for illuminating the decorative patterns of the decorative article. Therefore, the decorative pattern attains an enhanced clarity despite the lack of light source from the interior of a vehicle.

In an aspect, the invention features a decorative article for an automotive glazing. An interior layer, an exterior layer in side by side relationship with the interior layer, and a vinyl layer with a decorative pattern are arranged so that the vinyl layer is disposed between the interior and exterior layers. A ceramic pattern layer is disposed on the interior layer opposite the vinyl layer. The ceramic pattern layer has a light reflecting background for enhanced illumination of the decorative pattern of the vinyl layer.

In another aspect, the decorative article includes a decorative pattern in the form of an attachment such as decals or appliqués. A vinyl layer is disposed between interior and exterior layers. The attachment layer has a decorative pattern and is disposed on the exterior layer opposite the vinyl layer. A ceramic pattern layer is disposed on the interior layer opposite the vinyl layer. The ceramic pattern layer has a light reflecting background for enhanced illumination of the decorative pattern of the attachment layer.

In yet another aspect, the decorative article includes the decorative pattern in the form of a ceramic pattern layer. A vinyl layer is disposed between interior and exterior layers. A first ceramic pattern layer has a light absorbing decorative pattern and is disposed on the interior layer opposite the vinyl layer. A second ceramic pattern layer with a light reflecting background is disposed on the first ceramic pattern layer opposite the interior layer for illuminating the decorative pattern of the first ceramic pattern layer.

One example of producing a decorative article for an automotive glazing is first by providing an interior layer, an exterior layer, and a vinyl layer having a decorative pattern. Then, a ceramic pattern layer disposed on the interior layer opposite the vinyl layer is applied. The ceramic pattern layer is composed of dot pattern of ceramic frits. Finally by forming the interior and exterior layers in a side by side relationship with the vinyl layer. The vinyl layer is disposed between interior and exterior layers. The dot pattern has a configuration of a plurality of ceramic frits evenly spaced apart from each other to enhance illumination of the decorative pattern of the vinyl layer.

In embodiments where black ceramic frits, for example, are used to generate the decorative pattern, applying ceramic frits as contrasting and reflective background will drastically improve the visibility of the decorative pattern. Similarly, in embodiments where the decorative pattern is imparted in the polyvinyl butyral (PVB) interlayer, applying ceramic frits to serve as a reflective background to the decorative pattern will greatly enhance the clarity and vibrancy of the decorative pattern.

Further objects, features, and advantages of the present invention will become apparent from consideration of the following description and the appended claims when taken in connection with the accompanying drawings.

### BRIEF DESCRIPTION OF THE DRAWINGS

FIG. 1 is an environmental view of a vehicle having a windshield with a decorative article in accordance with one embodiment of the present invention;

FIG. 2 is an elevated view of the windshield shown in FIG. 1 having the decorative article;

FIG. 3 is a cross-sectional view of the decorative article of FIG. 2 taken along line 3-3 in accordance with one embodiment of the present invention;

FIG. 4 is a cross-sectional view of the decorative article of FIG. 2 taken along line 3-3 in accordance with another embodiment of the present invention;

FIG. 5 is a cross-sectional view of the decorative article of FIG. 2 taken along line 3-3 in accordance with yet another embodiment of the present invention;

FIG. 6 is a flow chart depicting one method of making the decorative article in accordance with one example of the present invention;

### DETAILED DESCRIPTION OF THE INVENTION

Embodiments of the present invention provide a contrasting or reflecting background for decorative graphic patterns on an automotive glazing and methods of making the reflective background. The present invention provides a solution to concerns of visibility and clarity of decorative graphic patterns applied to an automotive glazing. Generally, a ceramic pattern layer is applied to the interior layer of a decorative article to provide a contrasting or reflecting background surface relative to other graphic pattern or styling. As a result, the ceramic pattern provides an enhanced illumination of the decorative pattern of the vinyl layer.

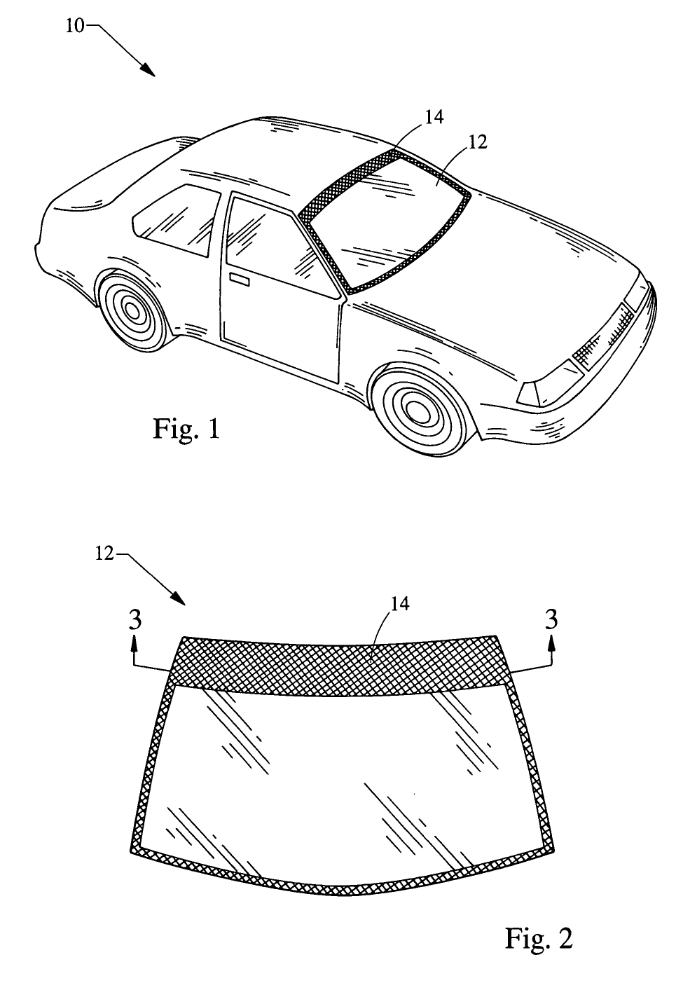

FIG. 1 illustrates a vehicle 10 having a windshield 12 including a decorative article 14 in accordance with one embodiment of the present invention. In this embodiment, the decorative article 14 can be applied to various parts of the automotive vehicle 10 glazing such as the body glass, backlites, moonroofs, or sunroofs and not just limited to the windshield 10 portion of the vehicle.

FIG. 2 depicts the windshield 12 having the decorative article 14 disposed on the windshield 12. As shown, the decorative article 14 is placed on a portion of the windshield 12 configured to avoid reduction of visibility to the driver. It is understood that the article 14 may be disposed on any suitable location on the windshield 12 without falling beyond the scope or spirit of the present invention so long as it does not affect the visibility of the driver.

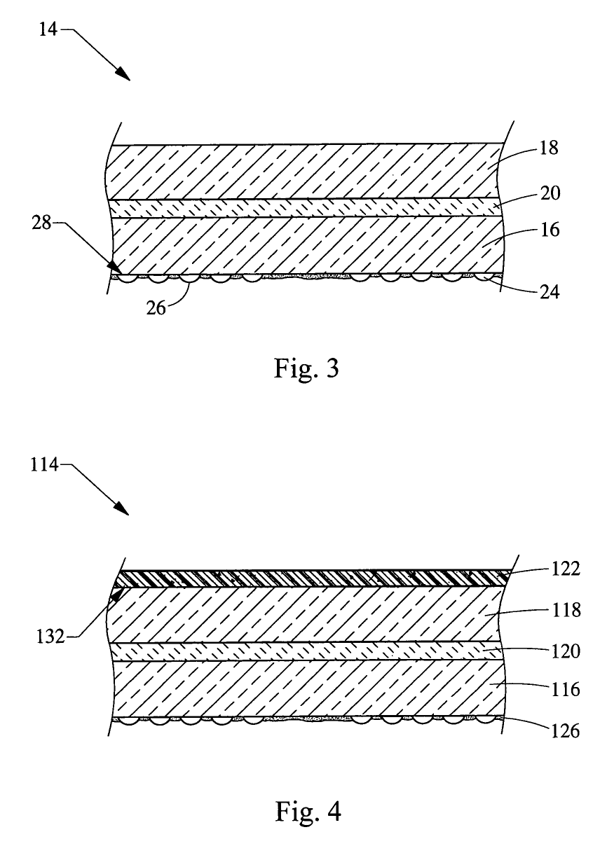

FIG. 3 illustrates a cross-section of one embodiment of the decorative article 14. In this embodiment of the present invention, the decorative article 14 contains an interior layer 16, an exterior layer 18 in side by side relationship with the interior layer 16, a vinyl layer 20 having a decorative pattern 22 and disposed between the interior and exterior layers 16, 18, and a ceramic pattern layer 24.

Suitable material for both the interior layer 16 and the exterior layer 18 include glass and other transparent material appropriate for use in an automotive windshield 12. The vinyl layer 20 is preferably made from a polyvinyl butyral (PVB) material. Commercially available PVB material for automotive windshield 12 can be obtained from various vendors. Additionally, a printed vinyl layer 20 having a predefined decorative pattern 22 embedded in the PVB material is available from DuPont Corp.

The ceramic pattern layer 24 is preferably formed by a predetermined pattern of ceramic paint containing substantially light reflecting frits 26. To provide a reflective background for the decorative pattern 22, the color of the light reflecting frits 26 will preferably be white or other lighter colors such as beige or tan. As shown in FIG. 3, the ceramic pattern layer 24 is applied to the interior surface 28 of the interior layer 16. Moreover, the ceramic pattern layer 24 is applied in a dot pattern to provide partial transparency through the decorative article 12.

In one example, the dot pattern may occupy about 40% of the decorative area on which the ceramic pattern layer is applied. Thus, about 60% of the decorative area is light transparent or open area. Preferably, the decorative area is occupied by greater than about 15% of the dot pattern, resulting in up to about 85% light transparent or open area relative to the exterior surface 30. As a result, the ceramic pattern provides an enhanced illumination of the decorative pattern of the vinyl layer.

FIG. 4 depicts a cross section of another embodiment of the decorative article 114. In this embodiment, the decorative article 114 includes an interior layer 116, an exterior layer 118, and a ceramic pattern layer 126 similar to the decorative article 14, the interior layer 16, the exterior layer 18 and the ceramic pattern layer 24 of the embodiment mentioned above. In this embodiment, the article includes also an attachment layer 122 having a decorative pattern 124, and a vinyl layer 120.

As shown, the attachment layer 122 is applied to the exterior surface 132 of the exterior layer 118 opposite the vinyl layer 120. The attachment layer 122 may be in the form of decals, paint, or appliqués having a decorative pattern 124. In this embodiment, the decorative pattern 124 is viewed from the exterior of the vehicle 10. As a result, the ceramic pattern provides an enhanced illumination of the decorative pattern of the attachment layer.

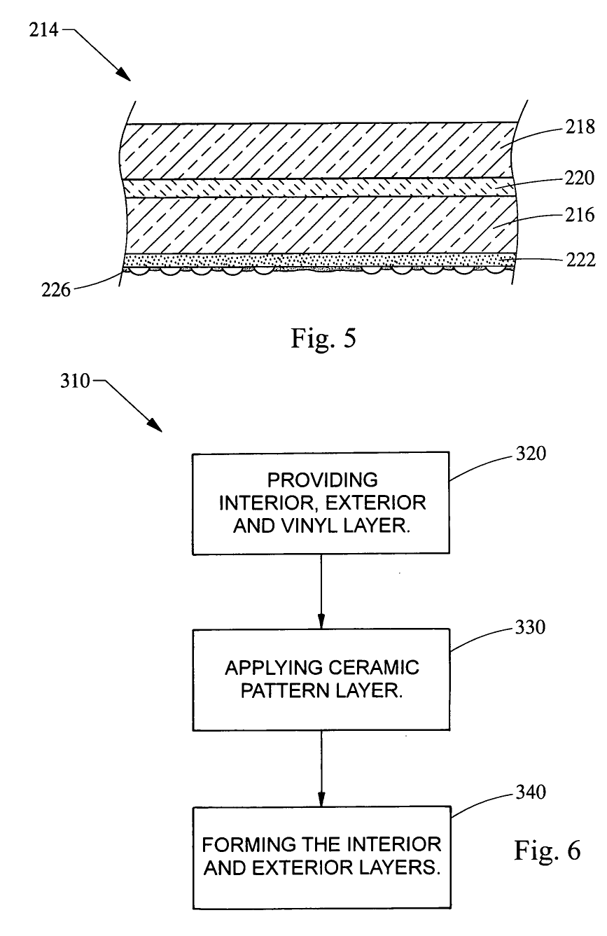

FIG. 5 shows a cross section of yet another embodiment of the decorative article 214. In this embodiment, the decorative article 214 includes an interior layer 216, an exterior layer 218, a vinyl layer 220, and a second ceramic pattern layer 226 similar to the decorative article 114, the interior layer 116, the exterior layer 118 and the ceramic pattern layer 124 of the embodiment mentioned above. In this embodiment, the article includes also a first ceramic layer 222 having a decorative pattern 224.

The first ceramic pattern layer 222 is preferably formed by a predetermined decorative pattern 224 of ceramic paint containing light absorbing frits 228. To provide a decorative pattern 224, the color of the light absorbing frits 228 is preferably black or other dark colors. As shown, the first ceramic pattern layer 222 is applied to the interior surface 230 of the interior layer 216 opposite the vinyl layer 220. Moreover, the first ceramic pattern layer 222 is applied in a dot pattern to provide partial transparency through the decorative article 214.

FIG. 6 illustrates a flow chart of one method 310 of making the decorative article 14 for an automotive glazing in accordance with one example of the present invention. As shown, the method 310 comprises providing the interior layer, the exterior layer, and the vinyl layer for the decorative article in box 320. As mentioned above, the interior layer and the exterior layer are preferably made of glass, which is capable of being formed into predetermined shape at an elevated temperature. The vinyl layer is preferably made of PVB material and may or may not contain any decorative pattern embedded in the PVB material.

The method 310 also comprises applying ceramic pattern layers to the interior surface of the interior layer in box 330. The ceramic pattern layer is preferably formed from a ceramic paint containing metal oxides and frits suspended in an organic vehicle. The ceramic frit is a finely ground form of glass binder also known as “flux”. The application of ceramic pattern layer to the interior layer is preferably a screen printing process. Silk-screened decorative glass is fabricated by transferring images or geometric designs to a glass surface. By using the same basic technology as in spandrel glass, the ceramic frit is applied to the glass through a fine mesh screen containing a standard or custom design. Screen printing is a process that allows precise control of the thickness of the mixture deposited and is suitable for mass production. The polyester mesh size of the screen, which controls the thickness of the deposit, is usually 230/inch with thread thickness of about 0.0015″. The higher the mesh count the thinner the deposit. It is also important that the interior surface of the interior layer be clean and dry before the application of the ceramic pattern layer.

In box 340, the interior and exterior layers are formed. In this example, the interior and interior layers are heated to the elevated temperature to soften the glass and to fuse the ceramic paint to the interior layer opposite the vinyl layer. The may be accomplished by setting the interior and exterior layers on metal baskets in contact at the periphery of each layer in a furnace. The furnace is then heated to the elevated temperature. In one embodiment, the elevated temperature is about 1150 degrees Fahrenheit (0° F.). At the elevated temperature, the ceramic frit melts and binds the metal oxides, while fusing to the interior layer on which it is applied. During heating, the layers drop or sag due to gravity to a desirable shape and contour of the windshield of the vehicle.

In this example, the vinyl layer is then disposed between the exterior and interior layers for adhering the interior layer to the exterior layer. As mentioned above, the vinyl layer preferably includes PVB. The interior and exterior layers are then aligned with each other and pressed or laminated together. Preferably, the interior and exterior layers are brought into an autoclaving process for high pressure treatment. For example, the autoclaving temperature may be at about 300° F. and the pressure may be at about 250 pounds per square inch (psi). Of course, other suitable parameters may be used. The vinyl layer serves to bond the interior and exterior layers together.

While the present invention has been described in terms of preferred embodiments, it will be understood, of course, that the invention is not limited thereto since modifications may be made to those skilled in the art, particularly in light of the foregoing teachings.

1. A decorative article for an automotive glazing, the article comprising:
an interior layer;
an exterior layer in side by side relationship with the interior layer;
a vinyl layer having a decorative pattern and disposed between the interior layer and the exterior layer; and
a ceramic pattern layer disposed on the interior layer opposite the vinyl layer, the ceramic pattern layer having a light reflecting background for enhanced illumination of the decorative pattern of the vinyl layer.

2. The article of claim 1 wherein the ceramic pattern layer comprises a uniform dot pattern disposed across the interior layer.

3. The article in claim 1 wherein the light reflecting background comprises white dots with between about 40% and 60% dot pattern coverage.

4. The article in claim 1 wherein the light reflecting background comprises white dots with about 40% dot pattern coverage and about 60% open area.

5. A decorative article for an automotive glazing, the article comprising:
an interior layer;
an exterior layer in side by side relationship with the interior layer;
a vinyl layer disposed between the interior layer and the exterior layer;
an attachment layer having a decorative pattern and disposed on the exterior layer opposite the vinyl layer; and
a ceramic pattern layer disposed on the interior layer opposite the vinyl layer, the ceramic pattern layer having a light reflecting background for enhanced illumination of the decorative pattern of the attachment layer.

6. The article of claim 5 wherein the ceramic pattern layer comprises a uniform dot pattern disposed across the interior layer.

7. The article in claim 5 wherein the light reflecting background comprises white dots with between about 40% and 60% dot pattern coverage.

8. The article in claim 5 wherein the light reflecting background comprises white dots with about 40% dot pattern coverage and about 60% open area.

9. A decorative article for an automotive glazing, the article comprising:
an interior layer;
an exterior layer in side by side relationship with the interior layer;
a vinyl layer disposed between the interior layer and the exterior layer;
a first ceramic pattern layer disposed on the interior layer opposite the vinyl layer, the first ceramic pattern layer having a light absorbing decorative pattern; and
a second ceramic pattern layer disposed on the first ceramic pattern layer opposite the interior layer, the second ceramic pattern layer having a light reflecting background for enhanced illumination of the first ceramic pattern layer.

10. The article of claim 9 wherein the ceramic pattern layer comprises a uniform dot pattern disposed across the interior layer.

11. The article in claim 9 wherein the light reflecting background comprises white dots with between about 40% and 60% dot pattern coverage.

12. The article in claim 9 wherein the light reflecting background comprises white dots with about 40% dot pattern coverage and about 60% open area.

13. A method of producing a decorative article for an automotive windshield, the method comprising:
providing an interior layer, an exterior layer, and a vinyl layer having a decorative pattern;
applying a ceramic pattern layer disposed on the interior layer opposite the vinyl layer, the ceramic pattern layer comprising a dot pattern of ceramic frits; and
forming the interior and exterior layers in a side by side relationship with the interior layer, the vinyl layer being disposed between the exterior and interior layers, the dot pattern having a configuration of a plurality of ceramic frits evenly spaced apart from each other to enhance illumination of the decorative pattern of the vinyl layer.
